(19) United States
(12) Patent Application Publication
(10) Pub. No.: US 2008/0257572 A1
(43) Pub. Date: Oct. 23, 2008

(54) Systems for Aerating Soil

(76) Inventor: Timothy Bowman, Cartersville, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/137,114

(22) Filed: Jun. 11, 2008

Related U.S. Application Data
(63) Continuation-in-part of application No. 11/692,604, filed on Mar. 28, 2007.
(60) Provisional application No. 60/813,202, filed on Jun. 13, 2006.
(60) Provisional application No. 60/918,754, filed on Mar. 19, 2007.

(51) Int. Cl. A01B 45/02

(52) U.S. Cl. 172/21

(57) ABSTRACT

Systems for aerating soil are provided. In this regard, a representative system includes: a plurality of aerating members, each of the aerating members having circumferential ends, longitudinal end portions, an aerating portion and aerating stud members, the end portions of the aerating members being angled with respect to the aerating portion; and a plurality of aerating stud members extending from the aerating portion of the aerating members; the aerating members being configured such that a circumferential end of a first of the aerating members attaches to a corresponding circumferential end of an adjacent one of the aerating members.

### CROSS-REFERENCE TO RELATED APPLICATIONS

This application is a Continuation-In-Part application that claims the benefit of and priority to U.S. Utility Patent Application, entitled “Systems for Aerating Soil”, having Ser. No. 11/692,604, filed Mar. 28, 2007, which claims the benefit of and priority to co-pending U.S. Provisional Patent Application entitled, “Mow-Aerator”, having Ser. No. 60/813,202, filed Jun. 13, 2006, U.S. Provisional Patent Application entitled, “Systems for Aerating Soil”, having Ser. No. 60/918,754, filed Mar. 19, 2007, and U.S. Provisional Patent Application entitled, “Systems for Aerating Soil”, having Ser. No. 60/943,145, filed Jun. 11, 2007, each of the aforementioned patent applications being entirely incorporated herein by reference.

### TECHNICAL FIELD

The invention relates to lawnmowers and aerating systems for lawnmowers.

### DESCRIPTION OF THE RELATED ART

Soil aeration allows air and water to enter the soil and contact the root systems of grass under the surface of the soil. This process results in a healthier lawn.

The majority of soil aeration is accomplished by the use of expensive commercial machinery dedicated to the task of soil aeration. These machines may aerate soil by driving holes in the soil or pulling out plugs of the soil. Use of such machines for performing soil aeration is inefficient for a number of reasons. For example, purchasing an aeration machine can be costly. Additionally, the use of a dedicated aeration machine requires subjecting a lawn to two passes, one while mowing the lawn, and a second while aerating the soil. Finally, there are millions of existing lawnmowers that are not designed to aerate soil. It is desirable that there be an apparatus that can easily fit on existing lawnmowers with out having to make substantial modifications to the lawnmowers. Prior machines used to both cut grass and aerate soil use complicated designs that are expensive to implement.

### SUMMARY

Systems for aerating soil are provided. In this regard, an exemplary embodiment of a system for aerating soil comprises: a plurality of aerating members, each of the aerating members having: two opposing end portions and an aerating portion, the end portions of the aerating members being angled with respect to the aerating portion, at least a first of the end portions being adjustable with respect to the aerating member such that an effective width between the end portions is changeable; a plurality of linking members, each of the linking members having two opposing end portions; an end portion of a first of the linking members, an end portion of a second of the linking members and an end portion of a first of the aerating members being aligned and moveably coupled with a first fastener such that an alternating series of the linking members and the aerating members are operative to form a loop for attaching to a tire; and a plurality of aerating stud members extending from the aerating portion of the aerating members.

Another exemplary embodiment comprises: a lawnmower having a plurality of wheels, each of the wheels having a tread surface and side wall surfaces; an aerating apparatus engaging one of the plurality of wheels; the aerating apparatus comprising a plurality of aerating members, each aerating member having end portions, an inner surface and an outer surface; the inner surfaces in contact with the tread surfaces, the end portions in contact with the side wall surfaces, at least one of the end portions of each of the aerating members being adjustable such that a width between corresponding end portions is alterable to accommodate different widths of wheels; a plurality of first and second linking members, each of the linking members having two opposing end portions; an end portion of a first linking member, an end portion of a second linking member and an end portion of a first of the aerating members being aligned and moveably coupled with fasteners; and a plurality of stud members attached to the outer surface of the aerating members.

Another exemplary embodiment comprises: a plurality of aerating members, each of the aerating members having circumferential ends, longitudinal end portions, an aerating portion and aerating stud members, the end portions of the aerating members being angled with respect to the aerating portion; and a plurality of aerating stud members extending from the aerating portion of the aerating members; the aerating members being configured such that a circumferential end of a first of the aerating members attaches to a corresponding circumferential end of an adjacent one of the aerating members.

Other systems, methods, features, and/or advantages of the present invention will be or may become apparent to one with skill in the art upon examination of the following drawings and detailed description. It is intended that all such additional systems, methods, features and/or advantages be included within this description and protected by the accompanying claims.

### BRIEF DESCRIPTION OF THE DRAWINGS

Many aspects of the invention can be better understood with reference to the following drawings. The components in the drawings are not necessarily to scale. Additionally, like reference numerals designate corresponding parts throughout the several views.

FIG. 1 is a perspective view illustrating an exemplary embodiment of a system for aerating soil.

FIG. 2 is a perspective view of a wheel to which an exemplary embodiment of a system for aerating is attached.

FIG. 3 is a view of an exemplary embodiment of a threaded linkage.

FIG. 4 is a view of an exemplary embodiment of a threaded stud removed from an aerating portion.

FIG. 5 is a perspective view of a wheel to which an exemplary embodiment of a system for aerating is attached.

FIG. 6 is a perspective view illustrating another exemplary embodiment of an aerating member.

FIG. 7 is a perspective view of a wheel to which an exemplary embodiment of a system for aerating is attached.

FIG. 8 shows an embodiment of an aerating system using a lawnmower.

FIG. 9 is a perspective view of a wheel to which another exemplary embodiment of a system for aerating is attached.

FIG. 10 is a perspective view of an aerating member of the system for aerating illustrated in FIG. 9.

### DETAILED DESCRIPTION

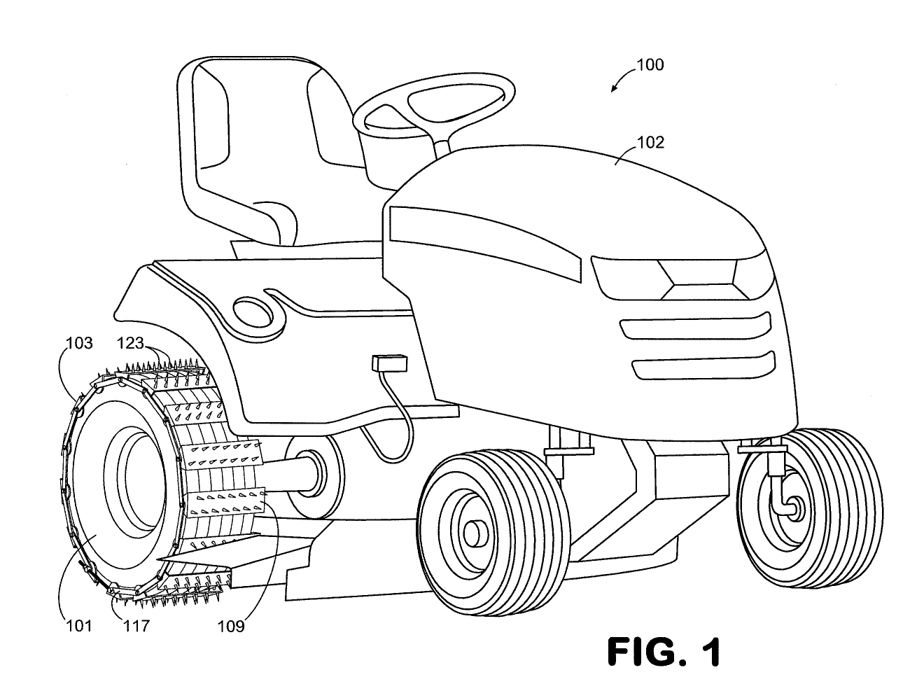

Systems for aerating soil are provided. Referring now in detail to the drawings, FIG. 1 is a perspective view illustrating an exemplary embodiment of a system 100 that incorporates a lawnmower and an aerating apparatus. In particular, the lawnmower 102, in this case, a riding lawnmower, has a wheel 101 engaged with an aerating apparatus 103. Those skilled in the art will understand that the aerating apparatus 103 may be used with a riding lawnmower, push lawnmower, tractor, or any other device that may use wheels to traverse a lawn.

The aerating apparatus 103 comprises a plurality of aerating members 109 linked together. The aerating members 109 are engaged by studs 123 and connected by linking members 117. The aerating members 109 engage the wheel 101 of the lawnmower 102. As the lawnmower 102 is driven on a lawn to cut grass, the aerating apparatus 103 drives holes in the soil with studs 123. These holes thereby allow air and water to contact the roots of grass resulting in healthier grass.

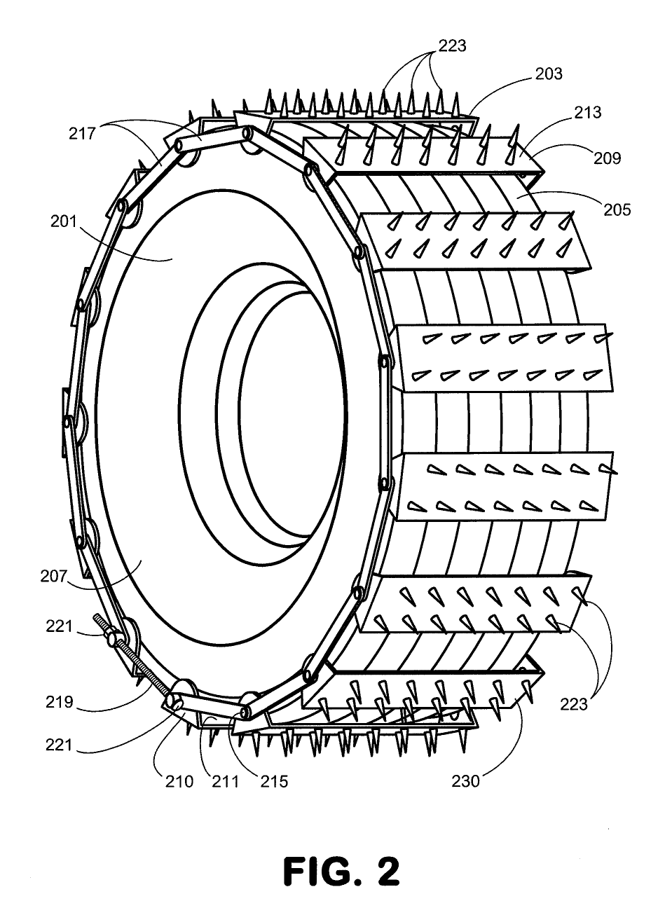

FIG. 2 is a perspective view of wheel 201, with sidewall 207 and tread surface 205 engaged with an embodiment of an aerating apparatus 203. Those skilled in the art understand that the tread surface 205 may have one of a variety of known tread patterns, or may be substantially smooth with no tread pattern. Aerating apparatus 203 comprises: a plurality of aerating members 209 having end portions 210, an aerating portion 230, an inner surface 211, and an outer surface 213. In this embodiment, the end portions 210 of each aerating member 209 are angled to be substantially perpendicular to the aerating portion 230 so that the inner surface 211 contacts the side walls 207 of the wheel 201. In this embodiment, each of the end portions 210 define a hole (not shown) so that a fastener 215 may be used to attach linking members 217 that link one aerating member 209 to another aerating member 209.

Linking a plurality of aerating members 209 together using the linking members 217 and fasteners 215, will result in an aerating apparatus 203 of sufficient length to fit the tread surface 205 of the wheel 201. The aerating apparatus 203 may be secured to the wheel 201 using threaded linking members 219. The threaded linking members 219 may engage the aerating apparatus 203 at end fasteners 221 that have a threaded bore (not shown) that receives the threaded fastener 219.

A user installs the aerating apparatus 203 by placing the aerating apparatus 203 on a wheel 201 so that the inner surfaces 211 of the aerating members 209 contact the sidewall 207 and the tread surface 205. A user turns the threaded linking members 219 using their hands or an appropriate tool (not shown) so that the aerating apparatus 203 is a length approximate to the length of the tread surface 205 of the wheel 201. The user may tighten the threaded linking members 219 so that the aerating apparatus 203 engages the wheel 201 without slipping while the wheel 201 is driven on soil.

The aerating member 209 has a plurality of studs 223 attached to the aerating portion 230. The studs 223 in this embodiment are in the shape of spikes. However, one skilled in the art would understand that the shape of the studs 223 is not limited to spikes and may include, as a non-limiting example, studs in a hollow shape that cut plugs in the soil, studs that have a rounded tip, substantially flat studs, or studs in a mushroom shape.

Once assembled and installed on the wheel 201 of a lawnmower (not shown), the aeration apparatus 203 may aerate the soil by driving holes into soil by means of the studs 223.

In operation, the end portions 210 are in contact with the sidewalls 207 of the wheel 201. The end portions 210 are operative to keep the aerating portion 230 aligned with the tread surface 205 of the wheel 201. As the lawnmower is driven on soil, the weight of the lawnmower acts to drive the studs 223 into the soil, thereby resulting in holes in the soil. In one embodiment, the linking members 217 may rotate on an axis substantially perpendicular to the fasteners 215. This rotation allows the aerating members 209 to move when force from the weight of the lawnmower is applied.

A person of ordinary skill in the art will understand that the aerating apparatus 203 may be assembled in a number of different configurations. For example, the aerating members 209 and the linking members 217 may be fabricated in a variety of shapes and dimensions in order to fit different sized and types of wheels or lawnmowers. Additionally, the aerating members 209 may not have a hole on each end to accommodate a fastener 215, but may have for example, a threaded stud or other type of fastener attached to the outer surface 213 of the aerating member 209.

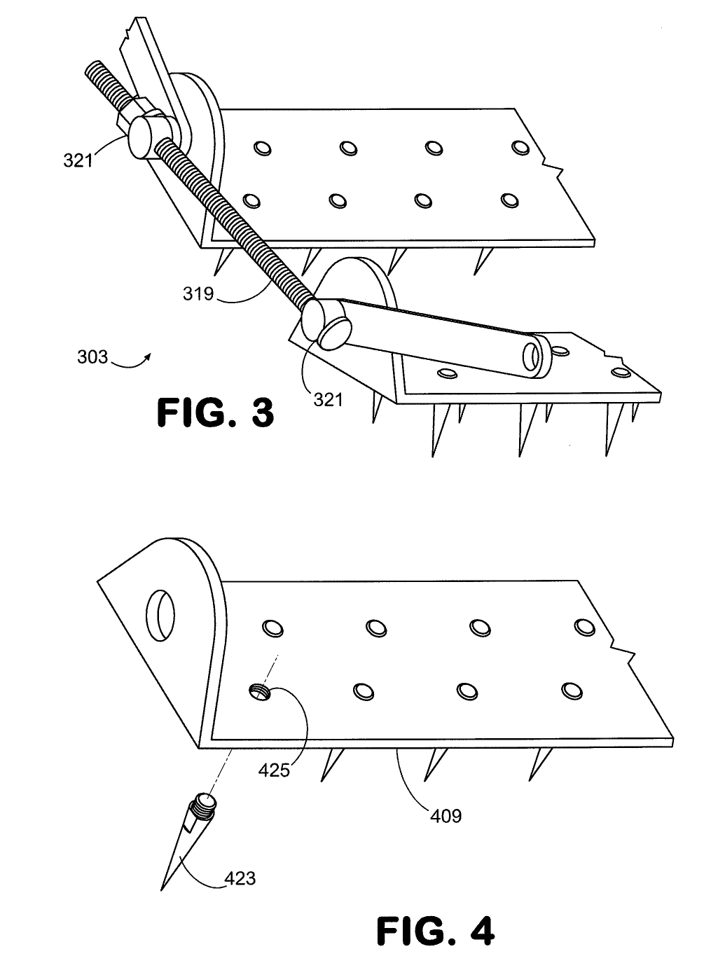

FIG. 3 shows the threaded linking members 319 engaging the end fasteners 321. The threaded linking members 319 may be rotated so that the distance between the end fasteners 321 may be adjusted. A threaded linking member 319 is used along both the inside and outside sidewalls of the wheel (not shown). The removal of the threaded linking members 319 from the aerating apparatus 303 allows for the removal of the aerating apparatus 303 from the wheel (not shown). One skilled in the art will understand that the threaded linking members 319 may be different lengths and types depending on the requirements of the embodiment.

FIG. 4 shows how, in one embodiment, the studs 423 may be removed from aerating member 409 by unscrewing the studs 423 from the threaded holes 425 in aerating member 409. This allows the studs 423 to be interchangeable. However one skilled in the art would realize that in alternate embodiments, the studs 423 may be permanently fixed to the aerating member 409.

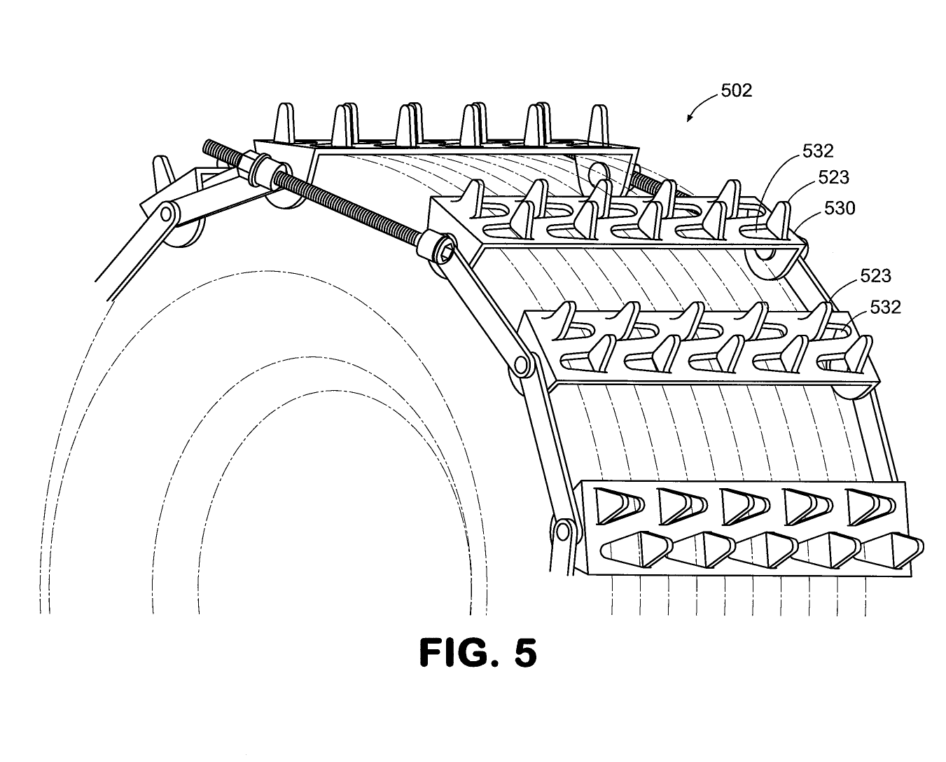

FIG. 5 shows one embodiment of the aerating apparatus 502. In the illustrated embodiment, the studs 523 may be fabricated by cutting the aerating portion 530 and bending the cut portions 532 of the aerating portion 530 outward so that a stud 523 is formed.

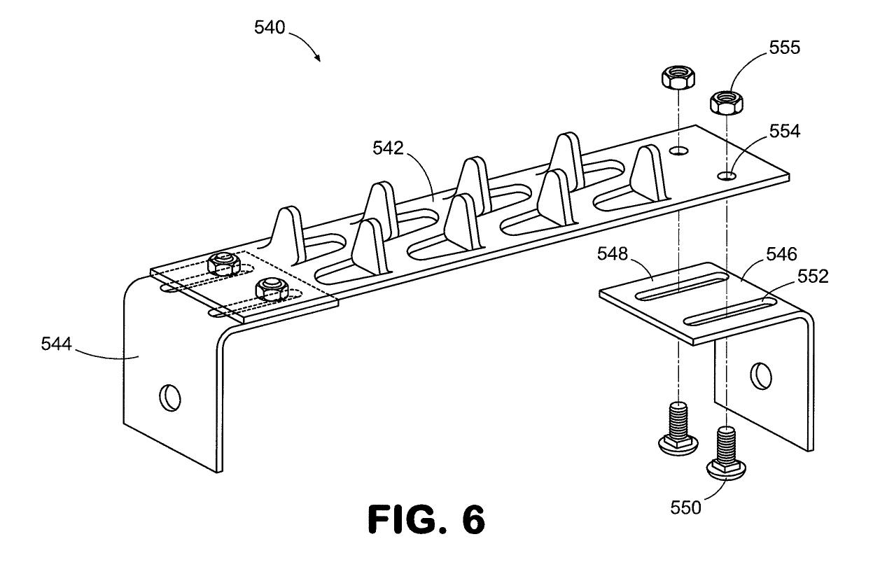

FIG. 6 is a perspective view illustrating another exemplary embodiment of an aerating member. As shown in FIG. 6, aerating member 540 is adjustable in width. Specifically, aerating member 540 includes an aerating portion 542 (which is generally planar and rectangular in this embodiment) and end portions 544 and 546. Each of the end portions incorporates an attachment flange (e.g., end portion 546 includes an attachment flange 548) that is used to attach the corresponding end portion to the aerating portion. In this embodiment, the end attachment flanges engage the underside (i.e., the wheel-facing side) of the aerating member. In other embodiments, however, attachment can be made at different locations.

Attachment of end portions to the aerating member is facilitated by mechanical fasteners (e.g., bolt and nut assemblies). In this embodiment, the fasteners are inserted within apertures of the attachment flanges and corresponding apertures of the aerating member. By way of example, bolt 550 is inserted through slot 552 of attachment flange 548, then through hole 554 of the aerating member, with the distal end of the bolt engaging a nut 555. Note that in this embodiment, two slots are used on each attachment flange with two corresponding holes being located on ends of the aerating member. In other embodiments, other configurations can be used, such as by locating the slots on the aerating member, for example.

In operation, the effective width of the aerating member can be adjusted to accommodate various tire widths. In particular, the mechanical fasteners associated with one or both of the end portions can be loosened so that the relative positions of the aerating member and end portions can be set as desired. Once set to the desired width, the fasteners can be tightened to secure the relative positions of the aerating member and end portions.

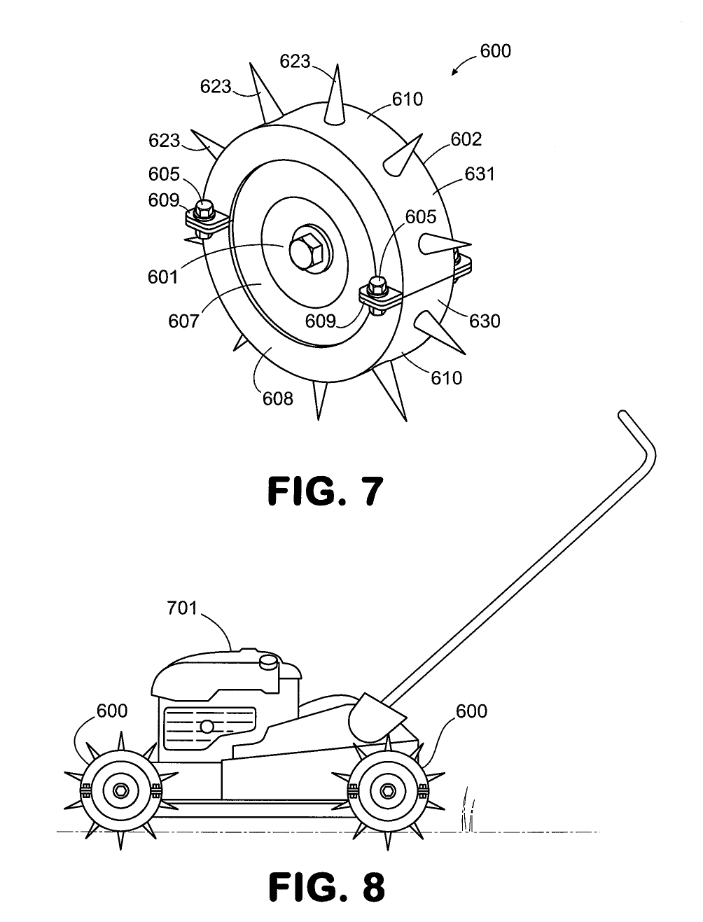

FIG. 7 shows an embodiment of an aerating system 600. The aerating apparatus 602 includes two aerating members 610. The aerating members 610 have aerating portions 630. Inner surfaces (not shown) of the aerating portions 630 contact the tread surface (not shown) of a wheel 601, and side wall portions 608 of the aerating members 610 contact the side wall 607 of the wheel 601. The aerating members 610 are secured to the wheel 601 by fasteners 605 that are inserted into holes (not shown) in flange portions 609. Studs 623 are attached to the outer surface 631 of the aerating portions 630.

One skilled in the art would understand that the studs 623 may be fabricated in the same manner as the studs illustrated in FIG. 5, and discussed above.

FIG. 8 shows an embodiment of an aerating system 600 using a push-type lawnmower 701.

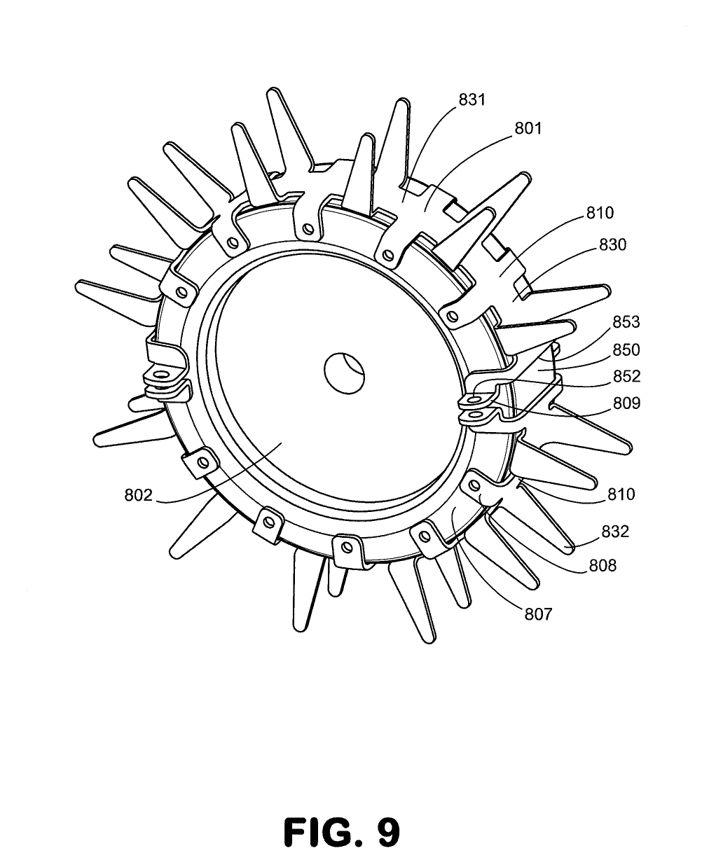

FIG. 9 shows an alternative embodiment of an aerating system. The aerating apparatus 801 includes two aerating members 810. The aerating members 810 have aerating portions 830. Inner surfaces (not shown in FIG. 9) of the aerating portions 830 contact a tread surface 850 of a wheel 802, and side wall portions 808 of the aerating members 810 contact the side wall 807 of the wheel 802. The aerating members 810 are secured to the wheel 801 by fasteners (not shown) that are inserted into holes 852 in flange portions 809. Notably, the flange portions are located at circumferential ends (e.g., end 853) of the aerating member. Studs 832 extend from the aerating portions 830.

In this embodiment, the aerating members 810 are constructed from a piece of metal that may be cut or stamped to form the shape of the aerating portions 830, the studs 832, the longitudinal end portions 808, the flange portions 809 and the holes 852. Once the shape of the aerating members 810 are formed they may be curved such that a profile of the aerating portions 830 is substantially similar to the curved profile of the tread surface 850 of the wheel 802 (i.e., each of the aerating members is arcuate in shape). The studs 832, the end portions 808, and the flange portions 809 are bent such that they form the shape as illustrated in FIG. 9.

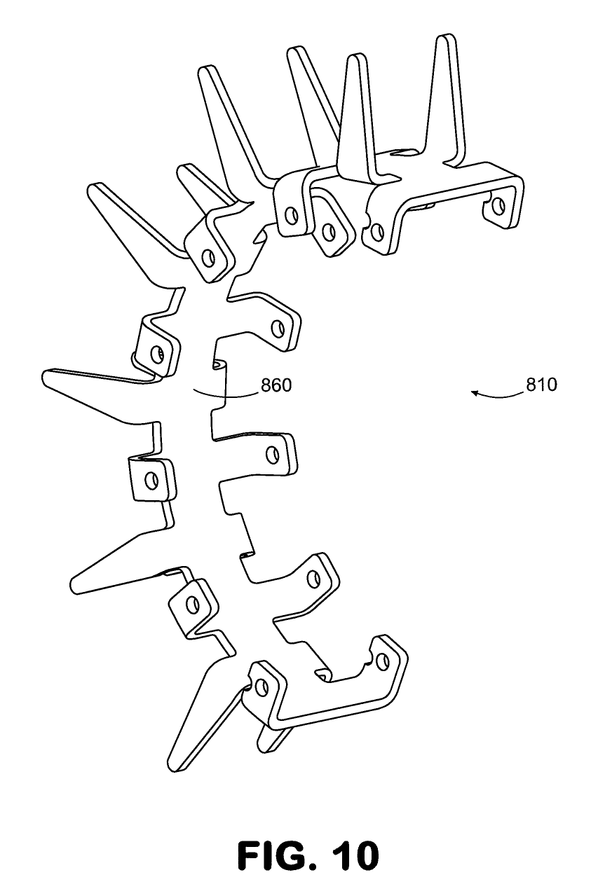

FIG. 10. Illustrates an aerating member 810, showing detail of the inner diameter surface 860 and construction of the exemplary studs.

The above-described embodiments may also be used for improving the traction of vehicles and lawn mowers on a variety of surfaces, including, mud, dirt, ice and snow. Additionally or alternatively, these embodiments may be used for breaking ice and snow to facilitate removal.

It should be emphasized that the above-described embodiments of the present systems and methods, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for aerating soil comprising:
a plurality of aerating members, each of the aerating members having:
two opposing end portions and an aerating portion,
the end portions of the aerating members being angled with respect to the aerating portion, at least a first of the end portions being adjustable with respect to the aerating member such that an effective width between the end portions is changeable;
a plurality of linking members, each of the linking members having two opposing end portions;
an end portion of a first of the linking members, an end portion of a second of the linking members and an end portion of a first of the aerating members being aligned and moveably coupled with a first fastener such that an alternating series of the linking members and the aerating members are operative to form a loop for attaching to a tire; and
a plurality of aerating stud members extending from the aerating portion of the aerating members.

2. The aerating system of claim 1, wherein at least two of the linking members are threaded linking members such that adjustment of the threaded linking members sets a tension of the loop for securing the aerating members about the tire.

3. The aerating system of claim 1, wherein the aerating stud members are spikes for aerating soil.

4. The system of claim 1, further comprising a lawn mower; and wherein the aerating apparatus engages a wheel of the lawnmower.

5. The aerating system of claim 1, wherein the aerating studs are removable.

6. The aerating system of claim 1, wherein the end portions of the aerating members are angled substantially perpendicular to the aerating portion.

7. The aerating system of claim 1, wherein the end portion of the first of the aerating members defines a hole operative to receive the first fastener.

8. The aerating system of claim 1, wherein the aerating portion further comprises a plurality of perforations, wherein each of the perforations defines a corresponding one of the plurality of aerating stud members.

9. An aerating system comprising:
a lawnmower having a plurality of wheels, each of the wheels having a tread surface and side wall surfaces;
an aerating apparatus engaging one of the plurality of wheels;
the aerating apparatus comprising a plurality of aerating members, each aerating member having end portions, an inner surface and an outer surface;
the inner surfaces in contact with the tread surfaces, the end portions in contact with the side wall surfaces, at least one of the end portions of each of the aerating members being adjustable such that a width between corresponding end portions is alterable to accommodate different widths of wheels;
a plurality of first and second linking members, each of the linking members having two opposing end portions;
an end portion of a first linking member, an end portion of a second linking member and an end portion of a first of the aerating members being aligned and moveably coupled with fasteners; and
a plurality of stud members attached to the outer surface of the aerating members.

10. The aerating system of claim 9, further comprising threaded linking members coupled to a second of the aerating members and being operative to set a tension of the aerating members about a wheel of a lawnmower.

11. The aerating system of claim 9, wherein the stud members are spikes for aerating soil.

12. The aerating system of claim 9, wherein the lawnmower is a riding lawnmower.

13. The aerating system of claim 9, wherein the studs are removable.

14. The aerating system of claim 9, wherein the outer surface of each of the plurality of aerating members further comprises a plurality of perforations, wherein each of the perforations defines a corresponding one of the plurality of stud members.

15. A system for aerating soil comprising:
a plurality of aerating members, each of the aerating members having circumferential ends, longitudinal end portions, an aerating portion and aerating stud members, the end portions of the aerating members being angled with respect to the aerating portion; and
a plurality of aerating stud members extending from the aerating portion of the aerating members;
the aerating members being configured such that a circumferential end of a first of the aerating members attaches to a corresponding circumferential end of an adjacent one of the aerating members.

16. The aerating system of claim 15, wherein each of the aerating members is arcuate in shape.

17. The aerating system of claim 15, wherein the aerating members are first and second aerating members that attach to each other at the circumferential ends thereof.

18. The aerating system of claim 15, wherein the longitudinal end portions are configured as pairs of opposing longitudinal end portions spaced circumferentially about the aerating members.

19. The aerating system of claim 15, further comprising mechanical fasteners operative to attach the aerating members together.

20. The aerating system of claim 15, wherein the aerating stud members are configured as pairs of aerating stud members spaced circumferentially about the aerating members.
